(19) United States
(12) Patent Application Publication
(10) Pub. No.: US 2025/0075899 A1
(43) Pub. Date: Mar. 6, 2025

(54) ENERGY STORAGE AND STEAM GENERATION SYSTEM AND METHOD

(71) Applicants: CHINA HUADIAN ENGINEERING CO., LTD., Beijing (CN); HUADIAN ENVIRONMENTAL PROTECTION SYSTEM ENGINEERING CO., LTD., Beijing (CN)

(72) Inventors: Xuan GANG, Beijing (CN); Mingzhong SHEN, Beijing (CN); Yongfeng BAI, Beijing (CN); Kailiang WANG, Beijing (CN); Yang WANG, Beijing (CN); Pengfei YANG, Beijing (CN); Xiaofu HU, Beijing (CN); Junhua SU, Beijing (CN); Zhengrong WANG, Beijing (CN); Jia HE, Beijing (CN)

(73) Assignees: CHINA HUADIAN ENGINEERING CO., LTD., Beijing (CN); HUADIAN ENVIRONMENTAL PROTECTION SYSTEM ENGINEERING CO., LTD., Beijing (CN)

(21) Appl. No.: 18/725,713

(22) PCT Filed: May 25, 2022
(86) PCT No.: PCT/CN2022/094876

§ 371 Date: Jun. 28, 2024

(30) Foreign Application Priority Data
Dec. 29, 2021 (CN) 202111640278.1

(51) Int. Cl. F22B 1/30; F22B 1/02; F22D 1/50; F22G 1/16

(52) U.S. Cl. CPC F22B 1/30; F22B 1/028; F22D 1/50; F22G 1/165

(57) ABSTRACT

Disclosed is an energy storage and steam generation system, including an electrode steam boiler. One side of the electrode steam boiler is connected with a boiler deaerator through a pipeline. A pipeline A is arranged at the top of the electrode steam boiler. The pipeline A is connected with a steam superheater, and an outlet of the steam superheater is provided with an external steam supply outlet pipeline. A molten salt steam generation bypass pipeline and a pipeline B are arranged on the steam superheater. One end of the molten salt steam generation bypass pipeline is connected to the steam superheater. A low-temperature molten salt storage tank is connected to the pipeline B, and a high-temperature molten salt storage tank is connected to the low-temperature molten salt storage tank through a pipeline. The other end of the molten salt steam generation bypass pipeline is connected to the high-temperature molten salt storage tank. Meanwhile, a generation method is further disclosed. According to the present disclosure, electric energy is converted into heat energy to be stored in the molten salt, and then energy is released for external steam supply by means of a method for generating steam through heating by coupling the molten salt, thereby realizing large-scale heat storage, prolonging the life of a heating system, and improving the reliability.

### TECHNICAL FIELD

The present disclosure relates to an energy storage and steam generation system and method, and belongs to the technical field of energy storage.

### BACKGROUND

Long-cycle, large-scale and low-cost energy storage technology is an important support for achieving the goal of carbon peaking and carbon neutrality, which is a cornerstone and a symbol of the construction of new energy power systems, and also the ultimate means for the power industry to get rid of carbon constraints. Currently, new energy storage technologies under research and development include molten salt energy storage, liquid air energy storage, compressed air energy storage, etc. Among them, molten salt energy storage technology is widely favored by the industry due to its advantages of long cycle, large scale, low cost, etc. In addition, the molten salt energy storage technology can be combined with existing coal-fired power plants to achieve large-scale energy storage while achieving unit deep peak shaving, frequency modulation, and external heat supply for coal-fired power plants.

For traditional electrically heated molten salt energy storage systems, resistive molten salt electric heating furnaces are the core equipment of the systems, and tubular electric heating elements are used to convert electric energy into heat energy to be stored in the molten salt. The traditional resistive heating method uses the heat energy generated by the Joule effect when currents flow through a resistance wire. Several electric heating elements are connected in parallel to achieve the power required by the heating furnace. Therefore, the main problem in resistive molten salt heating furnaces is to ensure the life and reliability of a large number of heating elements, so as to meet the normal operation of large-scale energy storage systems.

### SUMMARY

An object of the present disclosure is to provide an energy storage and steam generation system, and also provide an energy storage and steam generation method. According to the present disclosure, electric energy is converted into heat energy to be stored in the molten salt, and then energy is released for external steam supply or driving a steam turbine to do work by means of a method for generating steam through heating by coupling the molten salt through an electrode boiler, thereby realizing large-scale heat storage, and solving the problems of service life and reliability of the heating system caused by the traditional direct use of resistive heaters.

In order to solve the above technical problems, the present disclosure adopts the following technical solutions. An energy storage and steam generation system includes an electrode steam boiler. One side of the electrode steam boiler is connected with a boiler deaerator through a pipeline. A pipeline A is arranged at the top of the electrode steam boiler. The pipeline A is connected with a steam superheater, and an outlet of the steam superheater is provided with an external steam supply outlet pipeline. A molten salt steam generation bypass pipeline and a pipeline B are arranged on the steam superheater. One end of the molten salt steam generation bypass pipeline is connected to the steam superheater. A low-temperature molten salt storage tank is connected to the pipeline B, and a high-temperature molten salt storage tank is connected to the low-temperature molten salt storage tank through a pipeline. The other end of the molten salt steam generation bypass pipeline is connected to the high-temperature molten salt storage tank. Electric energy is converted into heat energy to be stored in the molten salt, and then energy is released for external steam supply or driving a steam turbine to do work by means of a method for generating steam through heating by coupling the molten salt through an electrode boiler, thereby realizing large-scale heat storage, and solving the problems of service life and reliability of the heating system caused by the traditional direct use of resistive heaters.

According to an energy storage and steam generation system described above, a water supply bypass pipeline is arranged on a pipeline section between the electrode steam boiler and the boiler deaerator. One end of the water supply bypass pipeline is connected to the pipeline section between the electrode steam boiler and the boiler deaerator. The other end of the water supply bypass pipeline is connected to the pipeline A. A feed water pump is arranged on a pipeline section between an inlet end of the water supply bypass pipeline and the boiler deaerator.

According to an energy storage and steam generation system described above, a preheater and a steam generator are sequentially arranged on the water supply bypass pipeline. The molten salt steam generation bypass pipeline also sequentially passes through the preheater and the steam generator.

According to an energy storage and steam generation system described above, a molten salt bypass pipeline is arranged on the molten salt steam generation bypass pipeline; and each of the preheater and the steam generator are disposed at a pipeline section between an inlet end and an outlet end of the molten salt bypass pipeline.

According to an energy storage and steam generation system described above, a molten salt electric heater is arranged on a pipeline section between the low-temperature molten salt storage tank and the high-temperature molten salt storage tank.

According to an energy storage and steam generation system described above, a low-temperature molten salt pump is arranged on the low-temperature molten salt storage tank, and a high-temperature molten salt pump is arranged on the high-temperature molten salt storage tank. The high-temperature molten salt pump is connected to the molten salt steam generation bypass pipeline. A molten salt steam bypass pipeline is arranged on the high-temperature molten salt pump. One end of the molten salt steam bypass pipeline is connected to the high-temperature molten salt pump, and the other end of the molten salt steam bypass pipeline is connected to the pipeline B.

According to an energy storage and steam generation system described above, a pipeline C is arranged between the molten salt steam generation bypass pipeline and the pipeline B. One end of the pipeline C is connected to a pipeline section between the preheater and the inlet end of the molten salt bypass pipeline, and the other end of the pipeline C is connected to a pipeline section between the molten salt steam generation bypass pipeline and the low-temperature molten salt storage tank.

An energy storage and steam generation method includes the following steps:

When there is excess electric energy that needs to be stored, starting the low-temperature molten salt pump to pump out molten salt from the low-temperature molten salt storage tank; and when the molten salt from the low-temperature molten salt storage tank passes through the molten salt electric heater, heating, by the molten salt electric heater, the molten salt from the low-temperature molten salt storage tank to be high-temperature molten salt and to be stored in the high-temperature molten salt storage tank; and

When energy is released, transporting water in the boiler deaerator to the electrode steam boiler through the feed water pump to be generated into saturated steam in the electrode steam boiler; and after the high-temperature molten salt from the high-temperature molten salt storage tank passes through the high-temperature molten salt pump and then passes through the molten salt bypass pipeline, exchanging heat of a part of the high-temperature molten salt with the saturated steam in the steam superheater, and then entering the external steam supply outlet pipeline after superheated steam is generated, where the part of the high-temperature molten salt turns into the low-temperature molten salt after exchanging heat and returns to the low-temperature molten salt storage tank via the pipeline B; and the other part of the high-temperature molten salt turns into the low-temperature molten salt after exchanging heat through the steam generator and the preheater sequentially and returns to the low-temperature molten salt storage tank via the pipeline C.

According to an energy storage and steam generation method described above, the electrode steam boiler is turned off and the molten salt steam generation bypass pipeline is opened when energy is released; the water in the boiler deaerator passes through the water supply bypass pipeline and the pipeline A sequentially via the feed water pump to be subjected to a countercurrent heat exchange with the high-temperature molten salt from the high-temperature molten salt storage tank by sequentially passing through the preheater, the steam generator, and the steam superheater via the salt steam generation bypass pipeline, so as to finally generate saturated steam to enter the external steam supply outlet pipeline; and the high-temperature molten salt from the high-temperature molten salt storage tank turns into low-temperature molten salt after exchanging heat through the steam superheater, the steam generator, and the preheater sequentially via the molten salt steam bypass pipeline and the molten salt steam generation bypass pipeline and returns to the low-temperature molten salt storage tank via the pipeline C.

According to the present disclosure, compared with the prior art, an electrode steam boiler and a molten salt steam superheater are provided on the basis of the differences in heating power in different temperature intervals during the process of heating, heating is carried out by the electrode steam boiler in the main energy-consuming steam generation process, and the superheater that consumes less energy is heated by the molten salt, which greatly reduces the number of resistive molten salt heaters, thereby improving the service life, reliability and economy of the system. According to the present disclosure, excess electric energy can be converted into heat energy to be stored in a high-temperature molten salt storage tank to play the role of large-scale energy storage. At the same time, combined with thermal power plants, the functions of peak shaving, frequency modulation and heat supply for thermal power units can be achieved, thereby extremely improving the flexibility and new energy consumption capabilities of thermal power units.

### BRIEF DESCRIPTION OF THE DRAWINGS

FIG. 1 is a schematic structural diagram of the present disclosure.

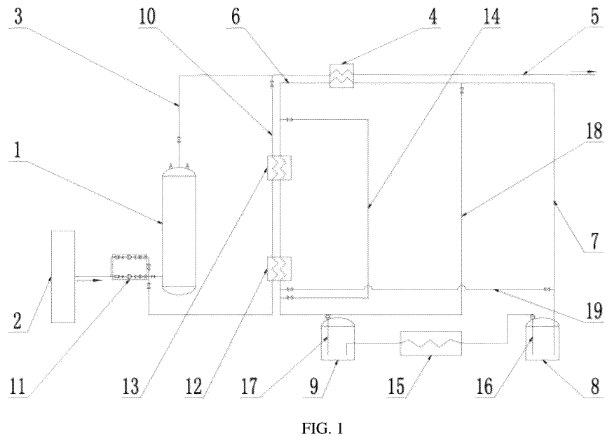

Reference numerals: 1—electrode steam boiler, 2—boiler deaerator, 3—pipeline A, 4—steam superheater, 5—external steam supply outlet pipeline, 6—molten salt steam generation bypass pipeline, 7—pipeline B, 8—low temperature molten salt storage tank, 9—high temperature molten salt storage tank, 10—water supply bypass pipeline, 11—feed water pump, 12—preheater, 13—steam generator, 14—molten salt bypass pipeline, 15—molten salt electric heater, 16—low temperature molten salt pump, 17—high temperature molten salt pump, 18—molten salt steam bypass pipeline, 19—pipeline C.

The present disclosure will be further described below in conjunction with the accompanying drawings and detailed description.

### DETAILED DESCRIPTION

Embodiment 1 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9.

Embodiment 2 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2.

Embodiment 3 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13.

Embodiment 4 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14.

Embodiment 5 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14. A molten salt electric heater 15 is arranged on a pipeline section between the low-temperature molten salt storage tank 8 and the high-temperature molten salt storage tank 9.

Embodiment 6 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14. A molten salt electric heater 15 is arranged on a pipeline section between the low-temperature molten salt storage tank 8 and the high-temperature molten salt storage tank 9. A low-temperature molten salt pump 16 is arranged on the low-temperature molten salt storage tank 8, and a high-temperature molten salt pump 17 is arranged on the high-temperature molten salt storage tank 9. The high-temperature molten salt pump 17 is connected to the molten salt steam generation bypass pipeline 6. A molten salt steam bypass pipeline 18 is arranged on the high-temperature molten salt pump 17. One end of the molten salt steam bypass pipeline 18 is connected to the high-temperature molten salt pump 17, and the other end of the molten salt steam bypass pipeline 18 is connected to the pipeline B 7.

Embodiment 7 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14. A molten salt electric heater 15 is arranged on a pipeline section between the low-temperature molten salt storage tank 8 and the high-temperature molten salt storage tank 9. A low-temperature molten salt pump 16 is arranged on the low-temperature molten salt storage tank 8, and a high-temperature molten salt pump 17 is arranged on the high-temperature molten salt storage tank 9. The high-temperature molten salt pump 17 is connected to the molten salt steam generation bypass pipeline 6. A molten salt steam bypass pipeline 18 is arranged on the high-temperature molten salt pump 17. One end of the molten salt steam bypass pipeline 18 is connected to the high-temperature molten salt pump 17, and the other end of the molten salt steam bypass pipeline 18 is connected to the pipeline B 7. A pipeline C 19 is arranged between the molten salt steam generation bypass pipeline 6 and the pipeline B 7. One end of the pipeline C 19 is connected to a pipeline section between the preheater 12 and the inlet end of the molten salt bypass pipeline 14, and the other end of the pipeline C 19 is connected to a pipeline section between the molten salt steam generation bypass pipeline 6 and the low-temperature molten salt storage tank 8.

Embodiment 8 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14. A molten salt electric heater 15 is arranged on a pipeline section between the low-temperature molten salt storage tank 8 and the high-temperature molten salt storage tank 9. A low-temperature molten salt pump 16 is arranged on the low-temperature molten salt storage tank 8, and a high-temperature molten salt pump 17 is arranged on the high-temperature molten salt storage tank 9. The high-temperature molten salt pump 17 is connected to the molten salt steam generation bypass pipeline 6. A molten salt steam bypass pipeline 18 is arranged on the high-temperature molten salt pump 17. One end of the molten salt steam bypass pipeline 18 is connected to the high-temperature molten salt pump 17, and the other end of the molten salt steam bypass pipeline 18 is connected to the pipeline B 7. A pipeline C 19 is arranged between the molten salt steam generation bypass pipeline 6 and the pipeline B 7. One end of the pipeline C 19 is connected to a pipeline section between the preheater 12 and the inlet end of the molten salt bypass pipeline 14, and the other end of the pipeline C 19 is connected to a pipeline section between the molten salt steam generation bypass pipeline 6 and the low-temperature molten salt storage tank 8.

An energy storage and steam generation method includes the following steps:

When there is excess electric energy that needs to be stored, starting the low-temperature molten salt pump 16 to pump out molten salt from the low-temperature molten salt storage tank 8; and when the molten salt from the low-temperature molten salt storage tank 8 passes through the molten salt electric heater 15, heating, by the molten salt electric heater 15, the molten salt from the low-temperature molten salt storage tank 8 to be high-temperature molten salt and to be stored in the high-temperature molten salt storage tank 9; and

When energy is released, transporting water in the boiler deaerator 2 to the electrode steam boiler 1 through the feed water pump 11 to be generated into saturated steam in the electrode steam boiler 1; and after the high-temperature molten salt from the high-temperature molten salt storage tank 9 passes through the high-temperature molten salt pump 17 and then passes through the molten salt bypass pipeline 14, exchanging heat of a part of the high-temperature molten salt with the saturated steam in the steam superheater 4, and then entering the external steam supply outlet pipeline 5 after superheated steam is generated, where the part of the high-temperature molten salt turns into the low-temperature molten salt after exchanging heat and returns to the low-temperature molten salt storage tank 8 via the pipeline B 7; and the other part of the high-temperature molten salt turns into the low-temperature molten salt after exchanging heat through the steam generator 13 and the preheater 12 sequentially and returns to the low-temperature molten salt storage tank 8 via the pipeline C 19.

Embodiment 9 of the present disclosure: An energy storage and steam generation system includes an electrode steam boiler 1. One side of the electrode steam boiler 1 is connected with a boiler deaerator 2 through a pipeline. A pipeline A 3 is arranged at the top of the electrode steam boiler 1. The pipeline A 3 is connected with a steam superheater 4. An outlet of the steam superheater 4 is provided with an external steam supply outlet pipeline 5. A molten salt steam generation bypass pipeline 6 and a pipeline B 7 are arranged on the steam superheater 4. One end of the molten salt steam generation bypass pipeline 6 is connected to the steam superheater 4. A low-temperature molten salt storage tank 8 is connected to the pipeline B 7. A high-temperature molten salt storage tank 9 is connected to the low-temperature molten salt storage tank 8 through a pipeline. The other end of the molten salt steam generation bypass pipeline 6 is connected to the high-temperature molten salt storage tank 9. A water supply bypass pipeline 10 is arranged on a pipeline section between the electrode steam boiler 1 and the boiler deaerator 2. One end of the water supply bypass pipeline 10 is connected to the pipeline section between the electrode steam boiler 1 and the boiler deaerator 2. The other end of the water supply bypass pipeline 10 is connected to the pipeline A 3. A feed water pump 11 is arranged on a pipeline section between an inlet end of the water supply bypass pipeline 10 and the boiler deaerator 2. A preheater 12 and a steam generator 13 are sequentially arranged on the water supply bypass pipeline 10. The molten salt steam generation bypass pipeline 6 also sequentially passes through the preheater 12 and the steam generator 13. A molten salt bypass pipeline 14 is arranged on the molten salt steam generation bypass pipeline 6. Each of the preheater 12 and the steam generator 13 are disposed at a pipeline section between an inlet end and an outlet end of the molten salt bypass pipeline 14. A molten salt electric heater 15 is arranged on a pipeline section between the low-temperature molten salt storage tank 8 and the high-temperature molten salt storage tank 9. A low-temperature molten salt pump 16 is arranged on the low-temperature molten salt storage tank 8, and a high-temperature molten salt pump 17 is arranged on the high-temperature molten salt storage tank 9. The high-temperature molten salt pump 17 is connected to the molten salt steam generation bypass pipeline 6. A molten salt steam bypass pipeline 18 is arranged on the high-temperature molten salt pump 17. One end of the molten salt steam bypass pipeline 18 is connected to the high-temperature molten salt pump 17, and the other end of the molten salt steam bypass pipeline 18 is connected to the pipeline B 7. A pipeline C 19 is arranged between the molten salt steam generation bypass pipeline 6 and the pipeline B 7. One end of the pipeline C 19 is connected to a pipeline section between the preheater 12 and the inlet end of the molten salt bypass pipeline 14, and the other end of the pipeline C 19 is connected to a pipeline section between the molten salt steam generation bypass pipeline 6 and the low-temperature molten salt storage tank 8.

An energy storage and steam generation method includes the following steps:

When there is excess electric energy that needs to be stored, starting the low-temperature molten salt pump 16 to pump out molten salt from the low-temperature molten salt storage tank 8; and when the molten salt from the low-temperature molten salt storage tank 8 passes through the molten salt electric heater 15, heating, by the molten salt electric heater 15, the molten salt from the low-temperature molten salt storage tank 8 to be high-temperature molten salt and to be stored in the high-temperature molten salt storage tank 9; and

Turning off the electrode steam boiler 1 and opening the molten salt steam generation bypass pipeline 6 when energy is released, where the water in the boiler deaerator 2 passes through the water supply bypass pipeline 10 and the pipeline A 3 sequentially via the feed water pump 11 to be subjected to a countercurrent heat exchange with the high-temperature molten salt from the high-temperature molten salt storage tank 9 by sequentially passing through the preheater 12, the steam generator 13, and the steam superheater 4 via the salt steam generation bypass pipeline 6, so as to finally generates the saturated steam to go into the external steam supply outlet pipeline 5; and turning the high-temperature molten salt from the high-temperature molten salt storage tank 9 into low-temperature molten salt after exchanging heat through the steam superheater 4, the steam generator 13, and the preheater 12 sequentially via the molten salt steam bypass pipeline 18 and the molten salt steam generation bypass pipeline 6 and returning to the low-temperature molten salt storage tank 8 via the pipeline C 19.

The working principle of an embodiment of the present disclosure is as follows: during working, when there is excess electric energy that needs to be stored, the low-temperature molten salt pump 16 is started to pump out molten salt from the low-temperature molten salt storage tank 8; when the molten salt from the low-temperature molten salt storage tank 8 passes through the molten salt electric heater 15, the molten salt from the low-temperature molten salt storage tank 8 is heated by the molten salt electric heater 15 to be high-temperature molten salt and to be stored in the high-temperature molten salt storage tank 9; the electrode steam boiler 1 is turned off and the molten salt steam generation bypass pipeline 6 is opened when energy is released; the water in the boiler deaerator 2 passes through the water supply bypass pipeline 10 and the pipeline A 3 sequentially via the feed water pump 11 to be subjected to a countercurrent heat exchange with the high-temperature molten salt from the high-temperature molten salt storage tank 9 by sequentially passing through the preheater 12, the steam generator 13, and the steam superheater 4 via the salt steam generation bypass pipeline 6, so as to finally generate saturated steam to enter the external steam supply outlet pipeline 5; and the high-temperature molten salt from the high-temperature molten salt storage tank 9 turns into low-temperature molten salt after exchanging heat through the steam superheater 4, the steam generator 13, and the preheater 12 sequentially via the molten salt steam bypass pipeline 18 and the molten salt steam generation bypass pipeline 6 and returns to the low-temperature molten salt storage tank 8 via the pipeline C 19.

1. An energy storage and steam generation system, comprising an electrode steam boiler (1), wherein one side of the electrode steam boiler (1) is connected with a boiler deaerator (2) through a pipeline; a pipeline A (3) is arranged at the top of the electrode steam boiler (1); the pipeline A (3) is connected with a steam superheater (4); an outlet of the steam superheater (4) is provided with an external steam supply outlet pipeline (5); a molten salt steam generation bypass pipeline (6) and a pipeline B (7) are arranged on the steam superheater (4); one end of the molten salt steam generation bypass pipeline (6) is connected to the steam superheater (4); a low-temperature molten salt storage tank (8) is connected to the pipeline B (7); a high-temperature molten salt storage tank (9) is connected to the low-temperature molten salt storage tank (8) through a pipeline; the other end of the molten salt steam generation bypass pipeline (6) is connected to the high-temperature molten salt storage tank (9); a water supply bypass pipeline (10) is arranged on a pipeline section between the electrode steam boiler (1) and the boiler deaerator (2); one end of the water supply bypass pipeline (10) is connected to the pipeline section between the electrode steam boiler (1) and the boiler deaerator (2); the other end of the water supply bypass pipeline (10) is connected to the pipeline A (3); a feed water pump (11) is arranged on a pipeline section between an inlet end of the water supply bypass pipeline (10) and the boiler deaerator (2); a preheater (12) and a steam generator (13) are sequentially arranged on the water supply bypass pipeline (10); the molten salt steam generation bypass pipeline (6) also sequentially passes through the preheater (12) and the steam generator (13); a molten salt bypass pipeline (14) is arranged on the molten salt steam generation bypass pipeline (6); and each of the preheater (12) and the steam generator (13) are disposed at a pipeline section between an inlet end and an outlet end of the molten salt bypass pipeline (14).

2. An energy storage and steam generation system according to claim 1, wherein a molten salt electric heater (15) is arranged on a pipeline section between the low-temperature molten salt storage tank (8) and the high-temperature molten salt storage tank (9).

3. An energy storage and steam generation system according to claim 1, wherein a low-temperature molten salt pump (16) is arranged on the low-temperature molten salt storage tank (8), and a high-temperature molten salt pump (17) is arranged on the high-temperature molten salt storage tank (9); the high-temperature molten salt pump (17) is connected to the molten salt steam generation bypass pipeline (6); a molten salt steam bypass pipeline (18) is arranged on the high-temperature molten salt pump (17); and one end of the molten salt steam bypass pipeline (18) is connected to the high-temperature molten salt pump (17), and the other end of the molten salt steam bypass pipeline (18) is connected to the pipeline B (7).

4. An energy storage and steam generation system according to claim 1, wherein a pipeline C (19) is arranged between the molten salt steam generation bypass pipeline (6) and the pipeline B (7), one end of the pipeline C (19) is connected to a pipeline section between the preheater (12) and the inlet end of the molten salt bypass pipeline (14), and the other end of the pipeline C (19) is connected to a pipeline section between the molten salt steam generation bypass pipeline (6) and the low-temperature molten salt storage tank (8).

5. A generation method for an energy storage and steam generation system according to any one of claims 1-4, comprising the following steps:
when there is excess electric energy that needs to be stored, starting the low-temperature molten salt pump (16) to pump out molten salt from the low-temperature molten salt storage tank (8); and when the molten salt from the low-temperature molten salt storage tank (8) passes through the molten salt electric heater (15), heating, by the molten salt electric heater (15), the molten salt from the low-temperature molten salt storage tank (8) to be high-temperature molten salt and to be stored in the high-temperature molten salt storage tank (9); and
when energy is released, transporting water in the boiler deaerator (2) to the electrode steam boiler (1) through the feed water pump (11) to be generated into saturated steam in the electrode steam boiler (1); and after the high-temperature molten salt from the high-temperature molten salt storage tank (9) passes through the high-temperature molten salt pump (17) and then passes through the molten salt bypass pipeline (14), exchanging heat of a part of the high-temperature molten salt with the saturated steam in the steam superheater (4), and then entering the external steam supply outlet pipeline (5) after superheated steam is generated, wherein the part of the high-temperature molten salt turns into the low-temperature molten salt after exchanging heat and returns to the low-temperature molten salt storage tank (8) via the pipeline B (7); and the other part of the high-temperature molten salt turns into low-temperature molten salt after exchanging heat through the steam generator (13) and the preheater (12) sequentially and returns to the low-temperature molten salt storage tank (8) via the pipeline C (19).

6. The generation method for an energy storage and steam generation system according to claim 5, wherein the electrode steam boiler (1) is turned off and the molten salt steam generation bypass pipeline (6) is opened when energy is released; the water in the boiler deaerator (2) passes through the water supply bypass pipeline (10) and the pipeline A (3) sequentially via the feed water pump (11) to be subjected to a countercurrent heat exchange with the high-temperature molten salt from the high-temperature molten salt storage tank (9) by sequentially passing through the preheater (12), the steam generator (13), and the steam superheater (4) via the salt steam generation bypass pipeline (6), so as to finally generate saturated steam to enter the external steam supply outlet pipeline (5); and the high-temperature molten salt from the high-temperature molten salt storage tank (9) turns into low-temperature molten salt after exchanging heat through the steam superheater (4), the steam generator (13), and the preheater (12) sequentially via the molten salt steam bypass pipeline (18) and the molten salt steam generation bypass pipeline (6) and returns to the low-temperature molten salt storage tank (8) via the pipeline
